(19) United States
(12) Patent Application Publication
(10) Pub. No.: US 2009/0013124 A1
(43) Pub. Date: Jan. 8, 2009

(54) ROM CODE PATCH METHOD

(75) Inventor: Yuval ITKIN, Zoran (IL)

Correspondence Address: CONNOLLY BOVE LODGE & HUTZ LLP, 1875 EYE STREET, N.W., SUITE 1100, WASHINGTON, DC, 20006, US

(73) Assignee: DSP Group Limited, Herzelia (IL)

(21) Appl. No.: 11/773,223

(22) Filed: Jul. 3, 2007

(51) Int. Cl. G06F 12/02

(52) U.S. Cl. 711/103; 711/E12.008

(57) ABSTRACT

The present invention relates to a method of replacing a sequence of one or more commands from a routine in a ROM of a device using a RAM. The method allows replacing part of a routine, for example a single command, while continuing to use the rest of the commands of the routine from the ROM. In an exemplary embodiment of the invention, a single command is replaced by adding only two additional commands or four additional commands as overhead in the replacement process.

### FIELD OF THE INVENTION

The present invention relates generally to a method of patching the code in a read only memory element incorporated into an electronic device.

### BACKGROUND OF THE INVENTION

Many mass production electronic devices are manufactured with an internal read only memory (ROM), which stores code for the functionality of the device (e.g. a calculator, and a mobile telephone). The ROM maintains the code without power being provided to the device. Generally, a specific size ROM is cheaper, smaller, less power consuming and provides a faster response time than other memory options, for example an EEPROM.

The problem with a ROM is that if errors are found in the code stored in the ROM the manufacturer needs to recall the device and replace the circuit or at least the ROM chip. To get around this problem manufacturers generally provide a small amount of writable non-volatile memory (e.g. an EEPROM) and a small amount of random access memory (RAM) to overcome errors in the ROM code. The manufacturer provides patch routines, which can be written to the EEPROM. When the device is powered on the patches are loaded from the EEPROM to the RAM to be executed instead of code in the ROM.

Typically the code in the ROM is provided with hooks (e.g. a conditional branch that tests a specific registry or memory value), at the beginning of the routines in the ROM. If a routine does not have a replacement, execution will continue with the code in the ROM, otherwise the code in the RAM will be used to replace the code in the ROM for that routine.

Generally, even if the error requires amending a single command, a whole replacement routine is provided, sometimes differing only by the single command. As a result after amending errors in a small number of routines, the RAM provided for the device will be filled up with the code for the device. Eventually the manufacturer will be forced to put out a new version of the device. Additionally, routines running from the RAM generally run slower than from the ROM. Thus each patch considerably reduces processing speed since the whole routine is replaced.

### SUMMARY OF THE INVENTION

An aspect of the invention, relates to a method of replacing a sequence of one or more commands from a routine in a ROM of a device using a RAM. The method allows replacing part of a routine, for example a single command, while continuing to use the rest of the commands of the routine from the ROM. In an exemplary embodiment of the invention, a single command sequence is replaced by adding only two additional commands or four additional commands as overhead in the replacement process. In an exemplary embodiment of the invention, each routine in the ROM begins with a hook command that conditionally branches to an address in the RAM if the routine needs to be amended. The address in the RAM contains commands that return execution back to the ROM to the command following the hook command and continue execution until the sequence of one or more commands in the ROM that need to be replaced. Execution is then transferred to execute the replacement commands in the RAM and then jump to the ROM to the command after the replaced commands to continue with the routine from the ROM. This allows a manufacturer to amend routines from a ROM without replacing the entire routine.

In some embodiments of the invention, the method requires the addition of a command to the command set of the processor of the device to support the above actions. Alternatively, the method may be implemented using a built in hardware debugger that is provided in the processor of the device.

There is thus provided according to an exemplary embodiment of the invention, a method of replacing a sequence of one or more computer processor commands from a routine in a read only memory of a device using a random access memory connected thereto, including:

placing a hook command at the beginning of the routine that conditionally transfers execution to an address in the random access memory if commands from the routine need to be replaced;

programming the device by placing commands in the random access memory to transfer execution to an address in the read only memory and execute one or more commands from the routine in the read only memory until the sequence of commands that need to be replaced;

then transferring execution to perform a sequence of one or more replacement commands in the random access memory;

returning execution to the command in the read only memory following the sequence of commands in the read only memory that is replaced; and

upgrading the processor to include a special command to enable performance of the above process if such a command is not available in the command set of the processor.

Optionally, the programming comprises executing a special command that transfers execution to the command following the hook command and executes commands until reaching a command from the sequence of commands. In an exemplary embodiment of the invention, the programming includes executing a special command that transfers execution to the command following the hook command and executes commands until reaching an address that is at a pre-calculated number of commands away from the command following the hook command. Optionally, the programming includes programming a hardware debugger in the processor of said device to define a break-point so that after executing the command before the sequence of commands that needs to be replaced execution is transferred to the sequence of one or more replacement commands in the random access memory. In an exemplary embodiment of the invention, replacement of a single command sequence from the read only memory requires use of two additional commands in the random access memory. Alternatively, replacement of a single command sequence from the read only memory requires use of four additional commands in the random access memory. In an exemplary embodiment of the invention, the random access memory is loaded with the replacement commands when the device is powered on. Optionally, the device is programmed by the commands in the random access memory to execute one or more commands from the routine in the read only memory starting form the command after the hook command.

There is thus further provided according to an exemplary embodiment of the invention, a device, comprising:

a central processing unit (CPU) for controlling functionality of the device;

a read only memory (ROM) with software routines for execution by the CPU to control functionality of the device;

a random access memory (RAM) to accept software routines to replace one or more commands from a software routine in said ROM;
wherein the CPU includes a special command that performs the following set of actions:

1. returns execution to the command following the special command that invoked it;

2. continues execution until a specific address and then transfers execution to the command following the special command.

### BRIEF DESCRIPTION OF THE DRAWINGS

The present invention will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of a circuit and instruction flow using absolute address referencing to patch ROM code with routines in RAM, according to an exemplary embodiment of the invention;

FIG. 2 is a schematic illustration of a circuit and instruction flow using relative address referencing to patch ROM code with routines in RAM, according to an exemplary embodiment of the invention;

FIG. 3 is a schematic illustration of a hardware debugger, according to an exemplary embodiment of the invention; and

FIG. 4 is a schematic illustration of a circuit and instruction flow using a hardware debugger to patch ROM code with routines in RAM, according to an exemplary embodiment of the invention.

### DETAILED DESCRIPTION

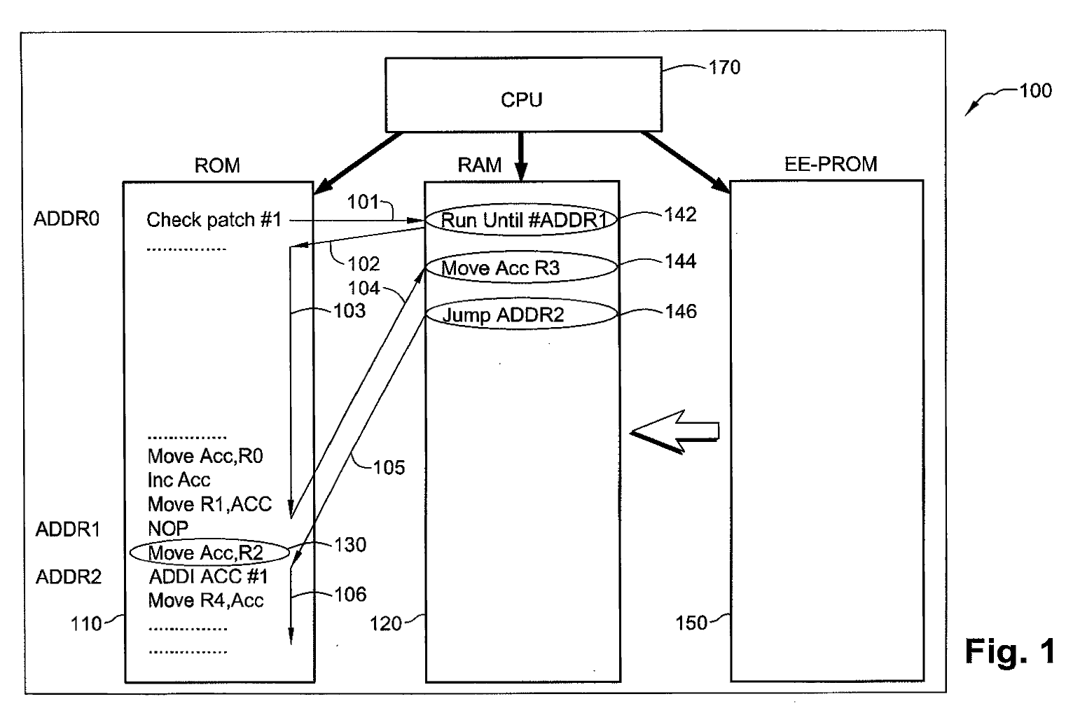

FIG. 1 is a schematic illustration of a circuit 100 and instruction flow using absolute address referencing to patch ROM code with routines in RAM, according to an exemplary embodiment of the invention. In an exemplary embodiment of the invention, circuit 100 includes a central processing unit (CPU) 170 to process software applications, and a ROM 110 with an application encoded as a sequence of computer processor commands, stored in it. Optionally, the sequence of computer processor commands controls functionality of the device, for example to control functionality of a mobile telephone. In an exemplary embodiment of the invention, if errors are discovered in the application code, instead of replacing circuit 100 or ROM 110 the device manufacture may provide a patch code, which is loaded to a non-volatile memory (e.g. an EEPROM 150) in the device. Optionally, when powering on the device, circuit 100 loads the patch code to a random access memory (RAM) 120, which will provide replacement commands for the code in ROM 110. In some embodiments of the invention, other methods are used to initially load the patch code to RAM 120. In an exemplary embodiment of the invention, CPU 170 is coded to include commands, which minimize the amount of RAM memory that will be required to amend errors in ROM 110.

In an exemplary embodiment of the invention, CPU 170 is coded (e.g. using micro-code commands during design of the processor) to include a command that will be referred to as a “RUN UNTIL address” command. The “RUN UNTIL address” command returns control to the command following the branch command that branched to it and instructs CPU 170 to execute commands until a specific address is reached. When the specific address is reached CPU 170 transfers control to the command following the “RUN UNTIL address” command.

In the example in FIG. 1 ROM 110 begins with a hook command, at address ADDR0, which performs a conditional branch. Optionally, when loading the content for RAM 120, CPU 170 will set flag values or register values for each routine in ROM 110 to indicate, which routine has a patch. Optionally, the hook command checks (e.g. using a conditional branch command relative to the flag values) to determine if the routine following the hook command in ROM 110 has been marked as containing an error and an amendment is provided in RAM 120. If an amendment is available in RAM 120 then CPU 170 transfers control (101) to the amendment routine at the address in RAM 120 provided by the hook command. In an exemplary embodiment of the invention, the amendment in RAM 120 will contain a “RUN UNTIL address” command 142 to transfer control back (102) to the original routine in ROM 110 and execute (103) all the commands that do not need to be replaced. Optionally, the address designated by “RUN UNTIL address” command 142 will be the address (ADDR1) of the command directly preceding the command that needs to be replaced, command 130. After executing the command preceding command 130 (at address ADDR1), CPU 170 transfers (104) execution to a command 144 following “RUN UNTIL address” command 142. Thus command 130 or any number of consecutive commands can be replaced by command 144 or any number of consecutive commands. Optionally, command 144 will be followed by a jump command 146 that will transfer (105) execution to the command following command 130 (at address ADDR2) and continue execution (106) of the rest of the commands of the existing routine in ROM 110.

As shown in FIG. 1 a single command 130 was replaced by three commands (142, 144, and 146) instead of repeating the entire routine from ROM 110 in RAM 120. Optionally, any original consecutive sequence of commands in ROM 110 can be replaced with a different set of consecutive commands in RAM 120, with the addition of only 2 commands (142, 146) without repeating the entire routine, thus minimizing the consumption of RAM 120 in amending routines.

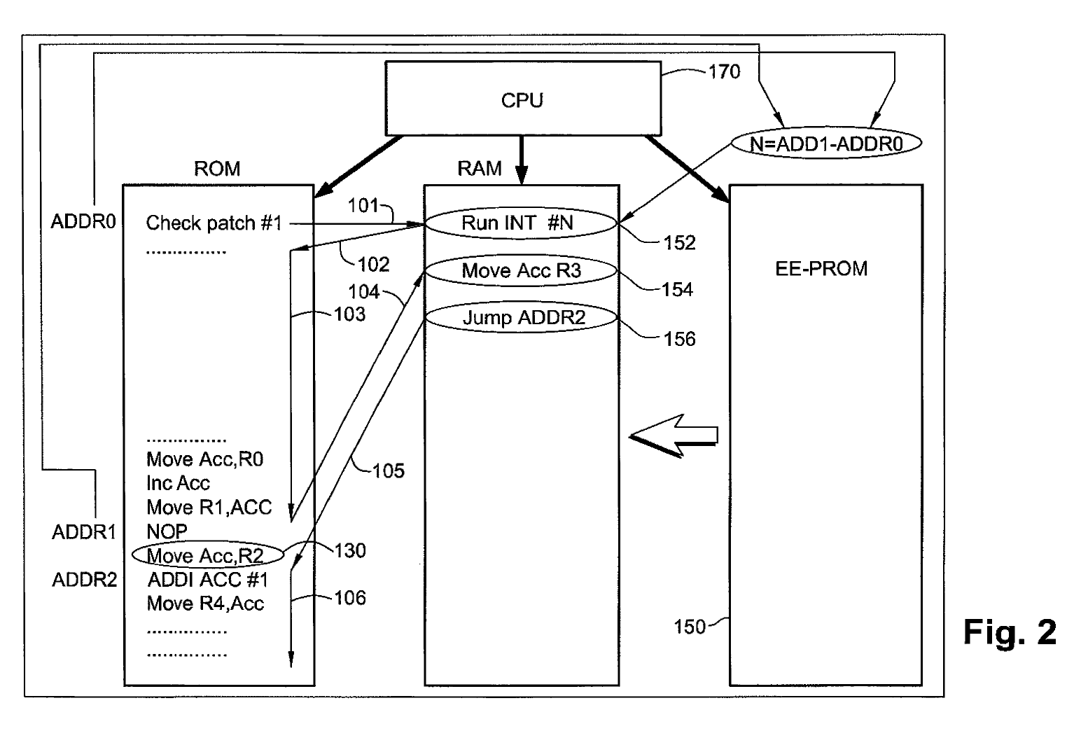

FIG. 2 is a schematic illustration of circuit 100 and instruction flow using relative address referencing to patch ROM code with routines in RAM, according to an exemplary embodiment of the invention.

In an exemplary embodiment of the invention, CPU 170 is coded to include a command that will be referred to as a “RUN INT N” command. The “RUN INT N” command returns control to the command following the branch command that branched to it and instructs CPU 170 to execute an integer number of commands (N) where N will be calculated to be the number of commands from the command following the hook command to the command preceding the command that needs to be replaced.

Similar to the description above regarding FIG. 1 in FIG. 2 the hook command will transfer (101) execution to the RUN INT N command 152. command 152 will transfer (102) execution back to the command following the hook command and CPU 170 will execute (103) the next N commands until command 130, which is to be replaced. CPU 170 will then transfer (104) execution to replacement command 154 after which a jump command 156 is placed to transfer (105) execution back to the ROM code and continue with the commands following replaced command 130.

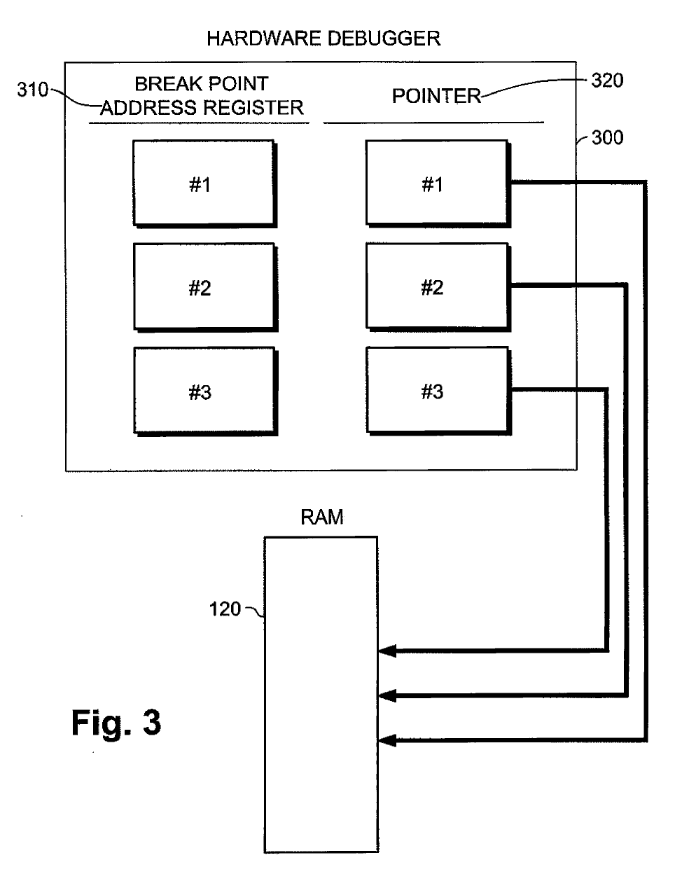

In some embodiments of the invention, one or more new commands are added to the instruction set of CPU 170 to support the implementation described above. Some processors already have built in support for hardware debugging, which may optionally be used to support the methods described above. FIG. 3 is a schematic illustration of a hardware debugger 300, according to an exemplary embodiment of the invention. An example of a processor which provides capabilities of a hardware debugger is the Motorola 56000 chip. In an exemplary embodiment of the invention, hardware debugger 300 includes one or more (e.g. 3) registers 310 into which a user provides memory addresses for the occurrence of breakpoints. Optionally, each register is associated with a pointer 320 which points to a routine which is performed when the respective breakpoint address is reached.

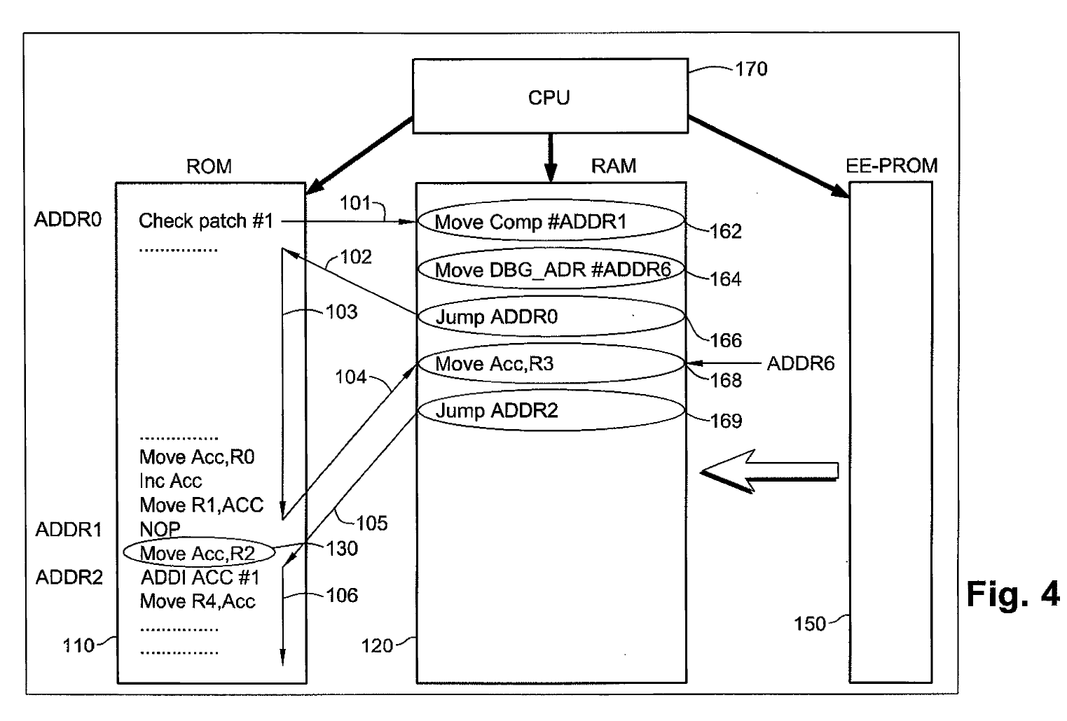

FIG. 4 is a schematic illustration of a circuit 100 and instruction flow using a hardware debugger to patch ROM code with routines in RAM 120, according to an exemplary embodiment of the invention. In an exemplary embodiment of the invention, a single command in ROM 110 is replaced by 5 commands (4 additional commands) in RAM 120. In an exemplary embodiment of the invention, the hook command at the beginning of the routine in ROM 110 transfers (101) execution to the patch routine in RAM 120. The patch routine places (command 162) the address (ADDR1) of the last command before the command that needs to be replaced into register 310 of the hardware debugger, so that an interrupt will occur after performing the last command (at address ADDR1). The patch routine places the address (ADDR6) of the replacement command (command 168) into the pointer 320 associated with register 310, so that when the interrupt occurs execution will commence with replacement command 168 (at address ADDR6). Optionally, after setting the hardware debugger values (310, 320) RAM 120 provides a JUMP command (command 166) to transfer (102) execution of the routine in ROM 110 (at the command after the hook command). Optionally, execution continues (103), until after performing the command at the debugging address (ADDR1). When the interrupt occurs execution is transferred (104) to the replacement command (command 168). Optionally, the replacement command (command 168) can be multiple commands, for example an entire routine. After executing the replacement command (command 168), a final JUMP command (command 169) is provided in RAM 120 to transfer (105) execution back to the address (ADDR2) after the command (command 130) or commands being replaced. Execution then continues (106) with the rest of the routine in ROM 110.

In an exemplary embodiment of the invention, the use of existing hardware debugger 300 allows using existing CPUs with built-in hardware debuggers instead of planning new CPUs with the commands suggested above (142, 152).

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

It will be appreciated by persons skilled in the art that the present invention is not limited to what has been particularly shown and described hereinabove. Rather the scope of the present invention is defined only by the claims, which follow.

1. A method of replacing a sequence of one or more computer processor commands from a routine in a read only memory of a device using a random access memory connected thereto, comprising:
placing a hook command at the beginning of the routine that conditionally transfers execution to an address in the random access memory if it determines that commands from the routine need to be replaced;
programming the device by placing commands in the random access memory to transfer execution to an address in the read only memory and execute one or more commands from the routine in the read only memory until reaching the sequence of commands that need to be replaced;
then transferring execution to perform a sequence of one or more replacement commands in the random access memory;
returning execution to the command in the read only memory following the replaced sequence of commands in the read only memory; and
upgrading the processor to include a special command to enable performance of the above process if such a command is not available in the command set of the processor.

2. A method according to claim 1, wherein said programming comprises executing a special command that transfers execution to the command following the hook command and executes commands until reaching a command from said sequence of commands.

3. A method according to claim 1, wherein said programming comprises executing a special command that transfers execution to the command following the hook command and executes commands until reaching an address that is at a pre-calculated number of commands away from the command following the hook command.

4. A method according to claim 1, wherein said programming comprises programming a hardware debugger in the processor of said device to define a break-point so that after executing the command before the sequence of commands that needs to be replaced execution is transferred to the sequence of one or more replacement commands in the random access memory.

5. A method according to claim 1, wherein replacement of a single command sequence from the read only memory requires use of two additional commands in the random access memory.

6. A method according to claim 1, wherein replacement of a single command sequence from the read only memory requires use of four additional commands in the random access memory.

7. A method according to claim 1, wherein said random access memory is loaded with the replacement commands when the device is powered on.

8. A method according to claim 1, wherein said device is programmed by the commands in the random access memory to execute one or more commands from the routine in the read only memory starting form the command after the hook command.

9. A device, comprising:
a central processing unit (CPU) for controlling functionality of the device;
a read only memory (ROM) with software routines for execution by said CPU to control functionality of the device;
a random access memory (RAM) to accept software routines to replace one or more commands from a software routine in said ROM;
wherein the CPU includes a special command that performs the following set of actions:
1. returns execution to the command following the special command that invoked it;
2. continues execution until a specific address and then transfers execution to the command following the special command.
